(19) United States
(12) Patent Application Publication
(10) Pub. No.: US 2004/0238629 A1
(43) Pub. Date: Dec. 2, 2004

(54) System and method for conducting sales of goods and retail store employing the same

(76) Inventor: Kenneth E. Buchholz, Cordova, TN (US)

Correspondence Address: Jerad G. Seurer, Wyatt, Tarrant & Combs, LLP, Suite 800, 1715 Aaron Brenner Dr., Memphis, TN, 38120-4367, US

(21) Appl. No.: 10/857,797

(22) Filed: May 28, 2004

Related U.S. Application Data
(60) Provisional application No. 60/474,384, filed on May 30, 2003.

(51) Int. Cl. G06K 15/00

(52) U.S. Cl. 235/383

(57) ABSTRACT

The present invention is directed to a system and method of conducting sales transactions. More particularly, the invention may be said to include a first station at which a customer may obtain a portable scanning device. This scanning device may be readily transported about a store and may be utilized to both scan and purchase the items selected by the customer. In addition, the invention generally includes a processor assembly that is wirelessly communicable with the portable scanning device. This feature may be characterized as enabling the customer to make a purchase from virtually any location in the store. After the desired items are purchased, an exit audit may be conducted in which an electronic scale assembly that is communicatively interconnected with the processor assembly is utilized to audit the purchase.

### RELATED APPLICATION

This application claims priority under 35 USC 119(e) to U.S. Provisional Application No. 60/474,384 entitled “System and Method for Conducting Sales of Goods” that was filed on May 30, 2003, which is incorporated herein by reference in its entirety.

### FIELD OF THE INVENTION

The present invention relates to sales of goods such as grocery items, and more particularly, to a system and method to facilitate conducting sales of such goods.

### BACKGROUND OF THE INVENTION

In a typical retail sales environment, a customer/consumer manually selects one or more items for purchase, transports the item(s) to a checkout station, and pays for the item(s) at the checkout station through the assistance of a human sales clerk. Indeed, in the context of grocery shopping, the customer removes one or more grocery items from an aisle of a supermarket, places the grocery item(s) into a shopping cart, basket, or the like, and transports the grocery item(s) to a checkout station for sales clerk-assisted purchase of the item(s). The sales clerk may manually enter data, such as sales price or a bar code number, indicative the item(s) to be purchased into an appropriate point-of-sale terminal (e.g., cash register and/or computer) at the checkout station. The sales clerk may also or alternatively utilize an appropriate scanning device that is generally hardwired to the checkout station to enter such data into the point-of-sale terminal. Typically, the point-of-sale terminal is utilized to calculate the total amount the customer must pay to purchase the goods, and a check, credit card, debit card, cash, or the like is tendered by the customer to the sales clerk to complete the sale. In the case where cash is utilized as the manner of payment, the sales clerk may utilize the point-of-sale terminal to calculate any change owing to the customer. In addition, the sales clerk generally utilizes the point-of-sale terminal to produce a written receipt memorializing the sale for the customer.

To reduce the time associated with a checkout portion of typical sales transactions, it has become quite prevalent for goods, or at least labels associated therewith, to each include a machine readable bar code (e.g., UPC). Indeed, this has enabled retailers to employ the above-mentioned scanning devices to more efficiently conduct sales transactions with at least generally less manual input being required from sales clerks. In other words, the sales clerk is able, at least in theory, to save time by scanning purchased items rather than having to manually key in price and/or product information. For instance, when the sales clerk scans a bar code associated with a product to be purchased, the scanning device generally sends a signal corresponding to the product to the point-of-sale terminal of the checkout station. This checkout station generally includes or is communicatively interconnected with a product database that includes pricing information of the scanned item (as well as other products in the store). Accordingly, a price for the item is automatically provided and calculated into a total amount due for the total sales transaction by the point-of-sale terminal without the need for significant manual input by the sales clerk.

The above-described manners of conducting sales have a number of drawbacks. For instance, many items, such as produce, may not have bar codes associated therewith, and, accordingly, may require a significant amount of time for manual entry of the corresponding data to complete the sale. Further, even though these checkout stations are equipped with scanning devices, the above-described methods generally require that a sales clerk be employed to work at each checkout station. This generally results in undesired operational overhead to the employer. Still further, these methods of conducting business have not been successful at reducing waiting periods for customers at the checkout station. Indeed, in the case where one customer is redeeming a plurality of coupons, buying a large quantity of items, and/or buying items that are not recognized or are incorrectly recognized by the checkout station scanning device, a subsequent customer in line behind that customer may have to wait a significant and undesired amount of time before it is her turn to purchase the selected item(s).

In efforts to reduce labor requirements, corresponding expenses, and other drawbacks associated with the above-described manners of sales transactions, what may be characterized as customer-operated checkout stations have been provided to the market place. In these customer-operated checkout stations, a customer may transport (e.g., via a shopping cart, basket, or the like) the items to be purchased to a checkout station that is fixed in location in the store. Once at this checkout station, the customer generally has to unload the item to be purchased from the transport and utilize a scanning device that is hardwired to the checkout station to scan each item to be purchased. Once an item to be purchased is scanned, the customer generally places the item on a scale or other appropriate weighing device of the checkout stand. Incidentally, a database associated with this type of system has both price and weight information associated with the bar code of each item. And, since most items have or can be packaged to have predetermined weights, the point-of-sale terminal of this system may be utilized to increase the probability that the product scanned is the same product that is placed on the scale. This is generally accomplished by comparing the actual weight of the product placed on the scale of the checkout station with the weight provided in the database. After the items to be purchased have been scanned and weighed, the customer then selects a payment method and purchases the products. If the chosen payment method includes a credit card, debit card, and/or cash, the customer may insert the same into a corresponding card reader or cash intake of the checkout stand. In the case where a paper check is the chosen method of payment, a sales clerk is employed to conduct that portion of the sales transaction. The customer is then generally required to reload the purchased products back into the transport to facilitate transfer of the purchased good to the customer's automobile.

These customer-operated checkout stations have also proven to exhibit a variety of undesirable limitations. For instance, a significant quantity of sales clerks must still be employed to supervise the checkout stations and may be a factor in the time efficiency of the process. For instance, to pay by check, a human sales clerk must be employed to review the check data and to complete the sales transaction. As another example, in the case that at least one of the items to be purchased is a controlled substance (e.g., alcohol or tobacco), these customer-operated checkout stations provide notice to a sales clerk or the like to manually analyze the customer's driver's license (or other appropriate age indicating identification) and manually authorize the sale of that controlled substance. As another drawback of these customer-operated checkout stations, the customer is forced to remove the items to be purchased from the basket, shopping cart, or the like, to weigh them and then undesirably undertake to reload the basket/shopping cart with the items after the items have been weighed. This inevitably results in an undesired waste of the customer's time and energy. Still yet another drawback is the time that may be wasted waiting in line to checkout behind someone redeeming a plurality of coupons, buying a large quantity of items, and/or buying items that are not recognized or are incorrectly recognized by the check-out station scanning device.

### SUMMARY OF THE INVENTION

Accordingly, it is an objective of the present invention to provide a system and method for conducting sales of goods that reduces operational overhead. It is another objective of the present invention to provide a system and method for conducting sales of goods that provides enhanced customer service. Still another objective of the invention is to provide a system and method for conducting sales of goods that is easy and/or enjoyable for customers to utilize. Relatedly, it is another objective to provide a system and method for conducting sales of goods that reduces a likelihood of time wasted waiting in checkout lines. Yet another objective of the invention is to provide a system and method for conducting sales of goods that provides substantially real-time discounting opportunities and/or purchase information while the customer is in an aisle of a store. Still yet another objective is to provide a system and method for conducting sales of goods that enables a customer to electronically authorize a purchase of one or more items while the customer is in an aisle (or the like) of a retail store. And yet another objective is to provide a system and method for conducting sales of goods that provides an at least generally reliable sales audit prior to an exit of the customer from the store or supermarket. A related objective is to provide a system and method of conducting sales of goods that at least generally reduces a likelihood of shoplifting incidents. These objectives, as well as others, may be met by the invention described below.

A first aspect of the present invention is directed to a method for conducting sales at a retail store, such as a sale of goods. In this method, a customer selects a first item for purchase by scanning a first bar code associated with the first item using a portable scanning device. Since this scanning device is indeed portable, the first item may be scanned at any appropriate location within the retail store, such as a first location (e.g., an aisle) within the retail store. The customer then purchases the first item using the portable scanning device. This purchase is accomplished via a wireless transmission of signal (e.g., radio frequency) between the portable scanning device and a processing unit of the retail store. Herein, to say that a customer “purchases” a particular item may be to say that the customer buys and, thus, generally acquires ownership of that item. In another characterization, to say that a customer “purchases” a particular item may be to say that title of that item passes to the customer in exchange for the customer providing consideration (e.g., to the retail store).

Any number of items may be selected and purchased utilizing this first aspect of the invention. For instance, the customer may also select a second item for purchase by scanning a second bar code associated with the second item using the portable scanning device. Again, due to the portable nature of the scanning device, the second item can be scanned at a second location (e.g., a different aisle) of the retail store that is remote (e.g., spaced and/or separate and distinct) from the first location. The customer may purchase the second item by initiating a wireless transmission of signal between the portable scanning device and the processing unit of the retail store. In the case where the customer selects the second item (e.g., scans the second bar code) and decides not to purchase the second item, the invention preferably enables the customer to deselect the second item in any of a number of appropriate manners. For instance, this deselection of the second item may include scanning the second bar code of the second item again using the portable scanning device.

One of the beneficial features of this first aspect of the invention is the portable nature of the scanning device, which enables desired items to be both selected and purchased at potentially any desired location within the retail store. In one light, to say that the scanning device is portable may be to say that the scanning device is easily transportable about the retail store by a single customer. Indeed, while the portable scanning device may exhibit any appropriate weight, it preferably weighs no more than about 5 pounds, more preferably no more than about 2 pounds, and still more preferably no more than about 1 pound. Further, while the portable scanning device may exhibit any appropriate dimensions and/or shape, the portable scanning device of at least one embodiment may at least generally resemble the size and/or shape of a telephone handset.

With regard to the purchase of the first and second items, the first item may be purchased at substantially the same time as the second item, or the first and second items may be purchased at different times. Indeed, this purchase of the first and second items may include transmission of a single signal or of multiple signals from the portable scanning device. The first and/or second items may be purchased by the customer at a third location that is remote from the first and second locations where the corresponding first and second items were selected (e.g., scanned). By contrast, the invention may provide the customer with the flexibility to purchase one or both of the first and second items at one or more of the above-described first and second locations of the retail store where the corresponding selections of the first and second items takes or took place.

Some embodiments of the first aspect of the present invention include an audit of the purchase(s) made by the customer after the purchase(s). In at least one embodiment; this audit generally includes weighing the first and/or second item(s). The first and/or second items may be weighed individually or cumulatively (e.g., collectively). The retail store may include one or more audit stations to provide at least portions of the above-described audit of the customer's purchase(s). Again, due to the portable nature of the scanning device, this auditing step may be undergone at any of a number of appropriate locations within the retail store, including one or more of the above-described first, second, and third locations of the retail store. Indeed, this audit (or at least a portion thereof) may occur at a fourth location of the retail store that is remote from the first, second, and third locations.

After selecting (e.g., scanning) the first and/or second item(s), the customer may place the first and/or second item(s) in an appropriate carrier such as a shopping cart or a shopping basket, and the audit of the subsequent purchase preferably includes weighing the corresponding first and/or second items. This weighing is preferably accomplished while the item(s) is located in the carrier. Accordingly, the carrier and the first and second items may be collectively weighed during the audit. This beneficial feature tends to alleviate or at least generally reduce undesired (and arguably unnecessary) loading and unloading of the carrier by the consumer, thus saving the consumer valuable time and/or labor.

Still with regard to the first aspect of the invention, once one or more desired items have been selected via scanning, the selection data may be at least temporarily stored in a memory of the portable scanning device and/or an appropriate database of the retail store. As such, the item(s) may be placed in a bag (e.g., plastic or paper grocery sack) shortly after selection of the items and even before purchasing the items. That is, since data indicative of each item has already been at least temporarily recorded/stored, there is generally no need to handle the item(s) again before purchasing the item(s). In this regard, this first aspect of the invention may be said to enable the customer to purchase the item(s) after the customer has placed the item(s) in one or more bags. While any of a number of appropriate bags may be utilized in this first aspect of the invention, it is preferred that the bags are at least generally translucent, and more preferably at least generally transparent. In one regard, this preference may be said to facilitate the audit of a customer's purchase in embodiments utilizing an auditing step. Indeed, if the auditing step includes a human-based visual inspection of the purchased goods, utilizing bags that allow a retail store employee to discern the contents thereof at least generally alleviates a need for removing one or more of the purchased items from the bag to accomplish such a visual inspection. Accordingly, it is generally preferred that the audit procedure be accomplishable without removing purchased item(s) from the bag(s) in which they are located.

In the audit of the customer's purchase(s), the first and/or second item(s) may be electronically examined to determine whether or not an appropriate security tag or the like is associated with one or both the first and second items. This examination may be accomplished in any appropriate manner known to those of ordinary skill in the art. In the case where a security tag is detected, at least one of an audible(e.g., alarm or the like) and a visual (e.g., light, display on a monitor, and/or the like) signal may be emitted.

The portable scanning device utilized in this first aspect may be any appropriate scanning device. Moreover, the retail store may provide the customer with a portable scanning device in any of a number of appropriate fashions. For instance; the retail store may include a support assembly that supports a plurality of the portable scanning devices. As such, the customer may remove one such portable scanning device from the support assembly upon (or shortly after) entering the retail store to enable the customer to accomplish the above-described selecting and purchasing of desired items. Further, upon completion of a desired number of selections and purchases, the customer may return the portable scanning device to the support assembly. In some embodiments, placing the portable scanning device back into association with the support assembly may initiate or trigger a printing of a sales receipt to memorialize the sales transaction that took place using the portable scanning device.

A sales receipt, such as the one mentioned above, may be printed at any appropriate stage in the method of this first aspect. For instance, a sales receipt may be printed after the selected item(s) has been purchased, yet before the auditing of that purchase. The sales receipt associated with this first aspect may include any appropriate indicia. For instance, one embodiment may exhibit a sales receipt having a receipt bar code printed thereon. In such an embodiment, the audit of the purchase may include scanning that receipt bar code. An image and/or biographical data (e.g., previously obtained in an enrollment step of the method) of the customer may be electronically displayed (e.g., on a television or computer monitor) in response to scanning the receipt bar code of the sales receipt. In some embodiments, based on the scanning of the receipt bar code, an electronic determination may be made as to whether or not one or more of the purchased items is a controlled substance such as tobacco products and/or alcoholic beverages. In the case that the purchased items do include one or more controlled substances, data indicative of an age of the customer may be compared to data indicative of a minimum legal age requirement to purchase the controlled substance. This comparison may be accomplished in any appropriate manner including electronically and/or via a human employee of the retail store.

A second aspect of the invention is also directed to a method of transacting a sale. In the method of this second aspect, a first item is selected for purchase by scanning a first bar code associated with the first item using a portable scanning device. The first item is then purchased, and, subsequently, that purchase is audited at least in part by weighing the first item and comparing a first weight corresponding to a theoretical weight of the first item to a second weight corresponding to an actual weight of the first item. Generally, a theoretical weight of a particular item refers to a predetermined weight that is electronically associated (or coupled) with a bar code of that item prior to the sale of that item.

In the case where first and second items are selected and purchased, a collective weight of the first and second items may be obtained during the audit of the purchase. In this case, the above-mentioned first weight may correspond to a cumulative theoretical weight of the first and second items, and the above-mentioned second weight may correspond to an actual cumulative weight of the first and second items. In contrast, the above-mentioned first weight may correspond to a cumulative theoretical weight of the first and second items as well as an item transport (e.g., shopping cart and/or basket) in which the first and second items are located, and the above-mentioned second weight may correspond to an actual cumulative weight of the item transport and the first and second items. Indeed, as a more general statement, in the case where more than two items (e.g., “n” number of items) are purchased, the first weight may correspond to a cumulative theoretical weight of the “n” items, and the second weight may correspond to an actual cumulative weight of the “n” items; or the first weight may correspond to a cumulative theoretical weight of the “n” items plus the item transport, and the second weight may correspond to an actual cumulative weight of the item transport and the “n” items.

Yet a third aspect of the invention is also directed to a method of transacting a sale. In this method, a loyalty card including data unique to the customer is issued to that customer. The loyalty card is electronically read, and a portable scanning device is activated (e.g., turned on) and/or is allowed to be removed from a structure supporting a plurality of such portable scanning devices in response to the loyalty card being electronically read. Subsequently, the customer may select a first item for purchase by scanning a first bar code associated with the first item using the portable scanning device and may purchase the first item using the portable scanning device.

The issuing of the loyalty card associated with this third aspect of the invention may be characterized, at least in one embodiment, as a step that would occur in an initial customer registration process of a retail store. Herein, a “loyalty card” refers to any appropriate card or the like that includes information that is readable by a card reader and/or scanner of the retail store in which the loyalty card is to be used. Moreover, the information included on this loyalty card may be any appropriate information including, but not limited to, the retail store name, logo, alphanumeric characters, symbols, a bar code, and a magnetic strip. Each loyalty card (e.g., via the bar code and/or magnetic strip provided thereon) preferably includes information specific to the customer to which it was issued. For instance, the information of the loyalty card may include payment data such as credit card information, debit card information, checking account information, and the like. Further, other information that may be associated with the loyalty card may be biographical data relating to the customer.

In issuing the loyalty card to the corresponding customer, visual image data of that customer and/or visual image data of a state-issued identification (e.g., driver's license) of that customer may be electronically stored (e.g., in an appropriate database of the retail store). During the auditing step of the method, a visual image corresponding to at least some of the visual image data may be displayed (e.g., on a appropriate screen or monitor). Displaying this digital image may serve a variety of beneficial purposes. For instance, it may allow an auditor to determine if the customer in possession of the loyalty card is the same customer to whom that loyalty card was issued. Incidentally, this digital image may be displayed during any appropriate portion of the auditing step. As an example, the digital image may be displayed while the purchased item(s) is being weighed.

Issuance of the loyalty card may include electronic storage of birth date data relating to the customer. This feature may be beneficial in regard to the purchase of controlled substances by the customer. For instance, the customer's loyalty card is read by the card reader to enable the customer to utilize the portable scanning device. Since the customer's loyalty card is preferably specific to that customer, a signal may be provided to the portable scanning device to allow or disallow attempted purchases of controlled substances based on the customer's birth date data. In other words, the customer's birth date data is preferably accessed before a purchase of a controlled substance is allowed. Moreover, the auditing step may include electronically displaying the customer's birth date data. This may or may not be done in combination with displaying any visual image data to confirm that the possessor of the loyalty card is indeed the customer to whom the loyalty card was issued. In other words, this method may be said to enable regulation of sales of controlled substances via use of the above-described loyalty cards.

Payment method data may also be electronically stored in the process of issuing a loyalty card to the customer. This payment method data may include manners of payment authorized by the customer (e.g., credit card, debit card, check, and the like), as well as account numbers corresponding to the authorized methods of payment. When the customer utilizes the portable scanning device to purchase the desired items, a query including the desired method of payment is preferably displayed. In other words, the payment method data may be accessed during the purchase (or attempted purchase) of the desired items. While not always the case, it is generally preferred that only the authorized method(s) of payment be displayed on the scanning device for the customer to choose from. For example, if the customer has authorized payment only by debit card or check, a choice relating to payment by credit card will preferably not be displayed. Selection of the desired payment method preferably corresponds with a wireless transmission of signal from the portable scanning device.

Still a fourth aspect of the invention is directed to a retail store and the components thereof in which a method of conducting sales (such as a method described herein) may be accomplished. This retail store generally includes a first station that has a support assembly and at least one portable scanning device that is supported or at least supportable by the support assembly. This support assembly may be any appropriate support assembly such as, but not limited to, a counter or table, a free-standing stand or rack, or a structure that is supported by (e.g., attached to) a wall. In one embodiment, this support assembly may be characterized as including a plurality of holsters or cradles, each of which is capable of accommodating a portable scanning device. In addition to the first station, the retail store also includes a processor assembly that is wirelessly communicable with the portable scanning devices. Herein, “wirelessly communicable” generally means that appropriate signals, such as radio frequency, can be transmitted between two or more things that are not hard-wire interconnected. In other words, even though no conductive material is utilized to interconnect the two things, signals may be effectively transmitted between them. In any event, a database is generally associated with the processor assembly. This database generally includes weight data and price data for each of a plurality of products. Moreover, this weight and price data are generally associated with an identification code (e.g., UPC) associated with each of the products. As yet another component, the retail store also includes a second station equipped with an electronic scale assembly that is communicatively interconnected with the processor assembly. Herein, “communicatively interconnected” or the like generally refers to a first thing being either directly or indirectly connected (or caused to be connected) with a second thing in a manner which enables at least an electrical signal to be conveyed between the first and second things.

The first station of this retail store may include any of a number of additional components. For instance, the first station may include an electronic card reader that is communicatively interconnected with the support assembly. This electronic card reader may be utilized for any of a variety of appropriate purposes. For instance, one of the above-described loyalty cards may be read by this electronic card reader to activate, ready, or at least facilitate the provision of one of the portable scanning devices for use by the customer.

Some embodiments of the first station may include a printer that is communicatively interconnected with the support assembly. This printer may be any appropriate printer. It is, however, preferred that the printer be capable of printing sales receipts to memorialize sales transactions that take place in the retail store. One benefit of having this printer be communicatively interconnected with the support assembly may be that the act of disposing a portable scanning device back into or on the support assembly may initiate a printing of a sales receipt that corresponds to the sales transaction undergone using that particular portable scanning device.

Some embodiments of the first station may include what may be characterized as a financial center. This financial center generally includes an electronic credit card reader, an electronic cash intake assembly, and an electronic change output assembly. While not always the case, this financial center is preferably in close proximity to the support assembly of the first station. Indeed, in some embodiments, this financial center may be directly connected to or even substantially integral (e.g., share a common housing) with the support assembly of the first station. At least in one embodiment, this financial center may be characterized as an apparatus that enables customers to make purchases using cash or other methods of payment that may or may not have been authorized by the customer at the time of issuance of the above-described loyalty card. In this regard, the financial center may also include a bar code scanner. Indeed, this bar code scanner may be utilized to recognize a bar code (e.g., on a selection receipt) that indicates that the selected items have not been paid for. Accordingly, upon recognition of this bar code, a balance owing may be displayed, and the customer may utilize a desired method of payment to purchase those items at the financial center. As such, the financial center may be equipped with a printer to provide a receipt indicating that the selected items have indeed been purchased.

The second station of the retail store may be characterized, in at least one embodiment, as an exit audit station. The electronic scale assembly of the second station is preferably utilized to weigh the purchased items. In some embodiments of the retail store, the second station may include a bar code scanner communicatively interconnected with the processor assembly. This bar code scanner preferably enables an auditor to have a bar code on the customer's receipt read to access data regarding one or more of the customer, the customer's purchase, and the customer's pending transaction(s). Additionally, the second station may include an appropriate display screen (e.g., television, monitor, or the like) communicatively interconnected with at least one of the electronic scale assembly and the processor assembly. This display screen may be utilized to display any appropriate data/image(s) including, but not limited to, data relevant to the exit audit. For instance, the display screen may be utilized to display information regarding the customer's current purchase. Further, the display screen may be utilized to display information regarding the age and/or identity of the customer. Still further, the display screen may be utilized to display information regarding the weight of the items purchased by the customer.

Yet a fifth aspect of the invention is directed to a method of using biometric traits specific to a customer of a retail store in transactions. More particularly, data indicative of one or more biometric traits of a customer may be stored in an appropriate database. Preferably coupled or associated with that biometric data is other data specific to that customer including photographic information (e.g., picture of the customer), biographical information (e.g., birth date) and/or payment information. Once a record including the biometric trait(s) and other desired data is stored, the customer may then utilize the biometric trait (at least in the retail store) as a sort of substitute for personal identification, a credit card, a check card, an electronic check, and the like. Indeed, this biometric trait may be utilized in addition to and or as a substitute for the above-described loyalty card.

While this fifth aspect of the present invention may apply to any appropriate biometric trait(s) that is substantially unique to each individual, the biometric trait of a fingerprint will be utilized to describe various features in relation to this fifth aspect. In some embodiments, scanning (e.g., infrared) of the customer's fingerprint (e.g., thumb print) may initiate or trigger a portable scanning device to be activated (e.g., turned on) and/or allowed to be removed from a structure supporting a plurality of such portable scanning devices. The customer may then select one or more items for purchase by scanning a bar code associated with each item using the portable scanning device. Indeed, it is preferred that the customer also be able to purchase the selected items using the portable scanning device.

In a registration portion of the method, visual image data of the customer and/or visual image data of a state-issued identification (e.g., driver's license) of that customer may be coupled with the customer's biometric data (e.g., fingerprint data) and electronically stored (e.g., in an appropriate database of the retail store). During an auditing step of the method, a scanning of the customer's fingerprint (at least some time in the method) may enable a visual image corresponding to at least some of the visual image data relating to the customer to be displayed (e.g., on a appropriate screen or monitor). This digital image may be displayed during any appropriate portion of the auditing step. As an example, the digital image may be displayed while the purchased item(s) is being weighed.

The coupling of birth date data with the customer's biometric data may serve any of a number of appropriate purposes. For instance, this feature may be beneficial in regard to the purchase of controlled substances by the customer. More particularly, the customer's fingerprint may be read or scanned by an appropriate fingerprint scanner to enable the customer to utilize the portable scanning device. Since the customer's fingerprint is specific to that customer, a signal may be provided to the portable scanning device to allow or disallow attempted purchases of controlled substances based on the customer's birth date data. In other words, the customer's birth date data is preferably accessed (due to the scanning of the customer's fingerprint) before a purchase of a controlled substance is allowed. Moreover, the auditing step may include electronically displaying the customer's birth date data.

One benefit of using biometric information in the invention is that biometric information is quite difficult to lose. For example, it is generally more likely that a customer would lose his wallet, credit card, checkbook, and/or loyalty card than it is that the customer would lose his finger. Since payment data and identification data is preferably coupled to the customer's biometric trait(s) in the invention, the customer is preferably able to purchase goods in the retail store without even bringing any conventional method of payment (cash, checkbook, credit/debit card) into the retail store. In other words, due to the linking the customer's identification and payment data to his biometric data in the database, the customer's fingerprint may be utilized as a substitute for in-store identification and/or an in-store method of payment.

Various refinements exist of the features noted in relation to one or more of the above-described aspects of the present invention. Further features may also be incorporated into one or more of those aspects of the invention as well. These refinements and additional features may exist individually or in any combination. Moreover, the various features discussed herein in relation to the present invention may be employed in any of the aspects of the invention, individually or in any combination.

### BRIEF DESCRIPTION OF THE DRAWINGS

FIG. 1 is a diagrammatic representation of a retail store.

FIG. 2 is a perspective view of a first station of a retail store.

FIG. 2A is a perspective view of a card reader assembly of the first station of FIG. 2.

FIG. 3 is a perspective view of a portable scanning device.

FIG. 4 is a perspective view of an exit audit station of the retail store of FIG. 1.

FIG. 5 is a perspective view of a computer monitor displaying customer data.

FIG. 6A is an elevation view of a front side of one embodiment of a loyalty card.

FIG. 6B is an elevation view of a back side of the loyalty card of FIG. 6A.

FIG. 7A is an elevation view of a front side of another embodiment of a loyalty card.

FIG. 7B is an elevation view of a back side of the loyalty card of FIG. 7A.

FIG. 8 is a flowchart illustrating a protocol for transacting sales.

FIG. 8A is a continuation of the flowchart from circle 8A of FIG. 8 illustrating steps involved in preauthorized payment by credit card, debit/ATM card, or electronic check.

FIG. 8B is a continuation of the flowchart from circle 8B of FIG. 8 illustrating steps involved in payment using a financial center of the retail store of FIG. 1.

FIG. 8C is a continuation of the flowchart from circle 8C of FIGS. 8A-8B illustrating steps involved in an exit audit of the protocol.

FIG. 9 is a flowchart illustrating a protocol for registering customers for the process of FIG. 8.

### DETAILED DESCRIPTION

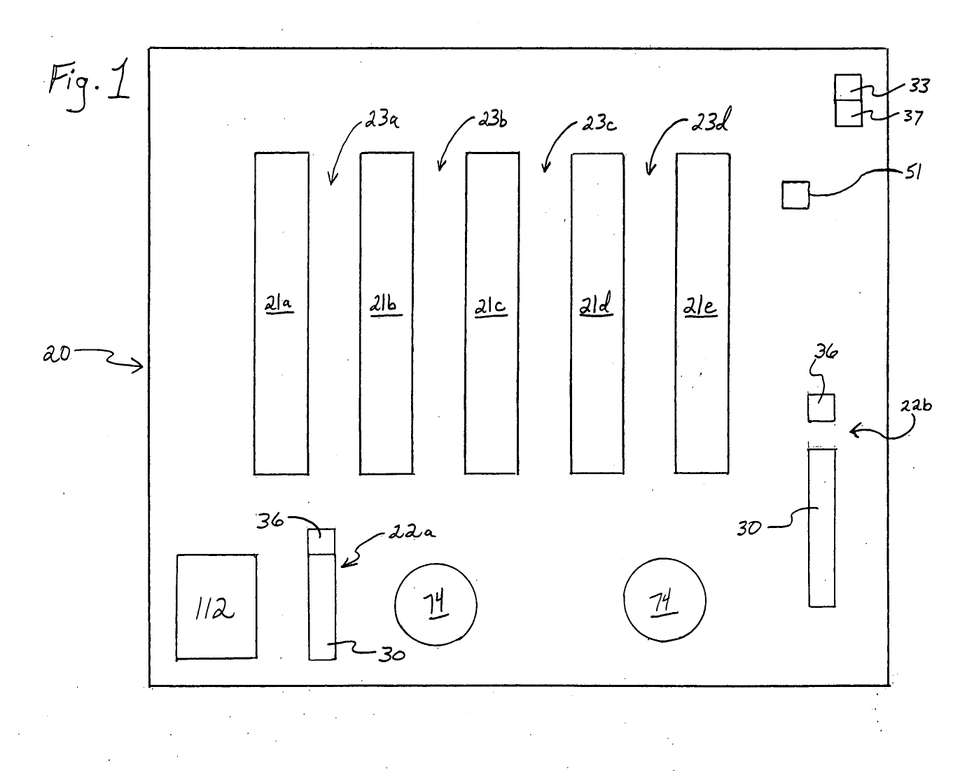

The present invention will now be described in relation to the accompanying drawings, which at least assist in illustrating the various pertinent features thereof. FIG. 1 schematically illustrates a retail store 20 that includes a plurality of shelving units 21a-e on which goods to be sold may displayed. An aisle 23 (e.g.,23a-d) of the retail store 20 is generally defined between adjacent ones of these shelving units 21a-e. This retail store 20 may be any store in the business of selling goods including, but not limited to, a supermarket, hardware store, office supply store, convenience store, super store, shopping center, department store, or the like. Moreover, some embodiments of the retail store 20 may include other appropriate apparatuses for displaying goods for sale other than (or in addition to) the plurality of shelving units 21a-e. For instance, some embodiments of the retail store may include racks and/or cases for display goods that are for sale. Incidentally, FIG. 1 is not meant to be to scale, nor to be indicative of the shape and/or size of the components illustrated therein.

The retail store 20 shown in FIG. 1 includes a novel system for conducting sales transactions. One part of this system is a first station 22 (e.g., 22a, 22b) that includes a support assembly 30 and a financial center 36. While two of these first stations 22a, 22b are illustrated in FIG. 1, it should be noted that other appropriate quantities of first stations 22 may be employed in other embodiments of the retail store 20. Further, a number of appropriate locations exist for the first station(s) 22 and the components thereof. Accordingly, the first station(s) 22 may be found in a variety of appropriate locations in various embodiments of the retail store 20.

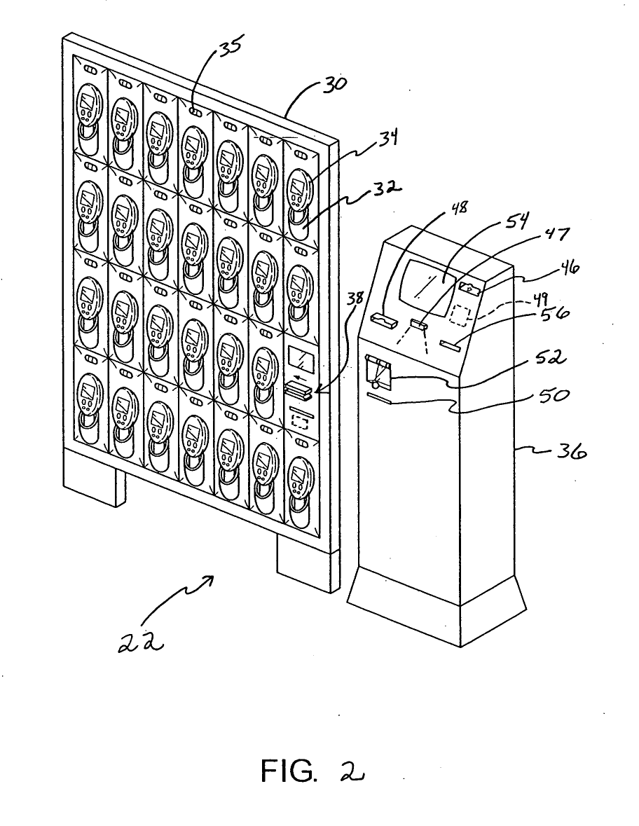

Referring to FIGS. 1-2, the support assembly 30 of the first station 22 may be characterized as a stand or a rack equipped with a plurality of receptacles 32 (e.g., holsters or cradles). Each of these receptacles 32 is preferably designed to accommodate at least a portion (e.g., a handle) of a portable scanning device 34. In this regard, it may be said that the support assembly 30 (via the receptacles 32 thereof) is capable of supporting a plurality of the portable scanning devices 34. One example of an appropriate support assembly 30 and/or scanning device 34 that may utilized in at least one embodiment of the system may be part of the PSS manufactured by Symbol Technologies, Inc., of Holtsville, N.Y. Incidentally, it should be noted that the support assembly 30 may exhibit any appropriate dimensions and can include any appropriate number of receptacles 32. Indeed, the support assembly 30 may include receptacles 32 on one or both sides thereof.

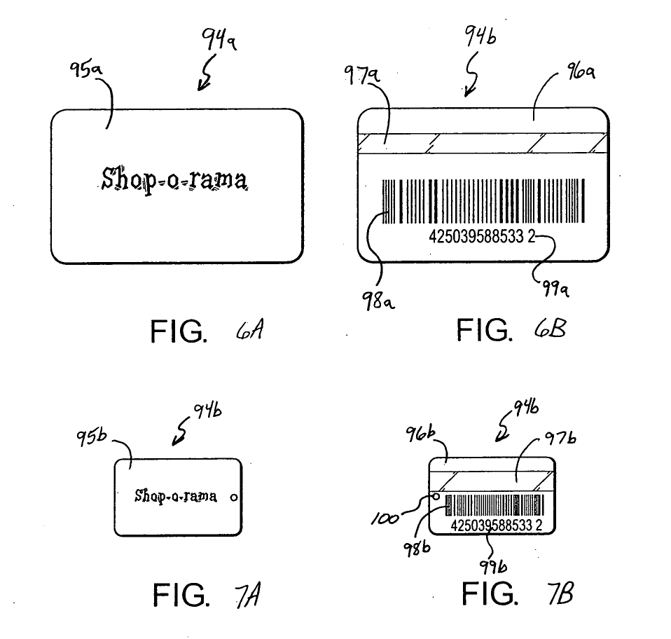

Referring to FIG. 2, the support assembly 30 of the first station 22 is equipped with a number of additional components. For instance, each receptacle 32 has an appropriate light emitting diode (LED) 35 or the like associated therewith. For that matter, each of the portable scanning devices 34 may include an appropriate LED (not shown). Referring to FIGS. 2-2A, the support assembly 30 also includes a card reader assembly 38. The card reader assembly 38 may be any appropriate card reader assembly capable of at least generally reading data from a consumer loyalty card 94 (FIGS. 6A-7B), for example, via a bar code and/or magnetic strip thereof. To accomplish this, the card reader assembly 38 is generally equipped with an appropriate card reader 40 (FIG. 2A). One example of any appropriate card reader that may be utilized in at least one embodiment of the card reader assembly 38 may be an entrance unit manufactured by Symbol Technologies of Holtsville, N.Y. In addition, the card reader assembly 38 is equipped with an appropriate display 42 that is located above the card reader 40. This display 42 is preferably utilized to convey appropriate information to the customer(s) and/or one or more retail store employees. Although not preferred, some embodiments of the card reader assembly 38 may not include a display 42. In such embodiments, the support assembly 30 may or may not include a display that is communicatively interconnected with the card reader assembly 38.

A printer 44 of the card reader assembly 38 of FIGS. 2-2A is shown below the card reader 40. In one characterization, it may be said that the printer 44 is positioned such that the card reader 40 is located at least generally between the display 42 and the printer 44. It should be noted that other embodiments of the support assembly 30 may exhibit other appropriate locations for the card reader 40, display 42, and/or printer 44. In any event, the printer 44 may be any appropriate printer capable of printing information on an appropriate substrate (e.g., paper). Indeed, in the illustrated embodiment, it is generally preferred that the printer 44 be capable of providing a customer with a paper receipt indicative of a sale or pending sale. While the printer 44 is shown as being a disposed at least generally within the card reader assembly 38 (or at least generally sharing a common facing therewith), other embodiments of the card reader assembly 38 may include a printer that is not substantially disposed within the card reader assembly 38 (e.g., a free standing printer). Incidentally, an example of an appropriate printer that may be utilized in at least one embodiment of the system may be a transaction printer manufactured by Transaction Printer Group, Inc., of Ithaca, N.Y.

While the support assembly 30 of FIG. 2 is illustrated as having only one card reader assembly 38, other embodiments of the support assembly 30 may be equipped with a plurality of card reader assemblies 38. Moreover, while the card reader assembly 38 is illustrated as being a component of the support assembly 30, other embodiments of the first structure 22 may include support structures 30 that are devoid of card reader assemblies, but have at least one (e.g., free standing) card reader assembly conmunicatively interconnected therewith. One variation of the support assembly 30 may include an appropriate device 39 to enable a customer's finger (or more particularly the fingerprint thereof) to be scanned. This fingerprint scanning device 39 may be utilized in addition to or as an alternative to the card reader 40 of the assembly 38. Incidentally, this fingerprint scanning device 39 may be any appropriate scanning device that is capable of at least assisting in electronically identifying a customer by scanning a finger (and/or fingerprint) of the customer.

Still referring to the first station 22 shown in FIGS. 1-2, a financial center 36 of the first station 22 may be associated with the support assembly 30 in any of a number of appropriate fashions. For instance, the financial center 36 of the first station 22a is shown as being attached to or abutting the corresponding support assembly 30. As another example, the financial center 36 of the first station 22b is shown as being spaced from the corresponding support assembly 30. While each first station 22, 22a, 22b is shown as having one financial center 36 paired with one support assembly 30, other embodiments of the retail store 20 may include first stations 22 having a plurality of support assemblies 30 and/or financial centers 36. Regardless of the particular arrangement of the support assembly(ies) 30 and the financial center(s) 36 of a given first station 22, it is generally preferred that each support assembly 30 be communicatively interconnected or wirelessly communicable with a financial center 36. In other words, it is generally preferred that signal provided from one of the support assembly 30 and the financial center 36 is capable of being conveyed to the other regardless of the manner in which the signal is transmitted.

This financial center 36 of the first station 22 of FIG. 2 is shown as including a number of components. Indeed, it is generally preferred that most (or more preferably all) of these components be included in the financial center 26 to provide customers of the retail store 20 with a broad range of payment options. For instance, the financial center 36 includes a card reader 46 that is capable of reading a bar code and/or a magnetic strip from a credit card, debit card, and/or customer loyalty card 94 (FIGS. 6A-7B). In addition, this financial center 36 is capable of facilitating a cash purchase by a customer. In this regard, the financial center 36 is equipped with a cash intake 38 to receive cash, a cash return 50 to provide any cash-based change owing, and a coin return 52 to provide any coin-based change owing. In addition, the financial center 36 is equipped with an appropriate display 54. This display 54 may be any appropriate display such as, for example, a touch screen. Moreover, this display 54 is preferably utilized to convey appropriate information to the customer(s) and/or one or more retail store employees. Yet another component of the financial center 36 is a printer 56. The printer 56 may be any appropriate printer capable of printing information on an appropriate substrate (e.g., paper). Indeed, in the illustrated embodiment, it is generally preferred that the printer 56 of the financial center 36 be capable of providing a customer with a paper receipt indicative of a sale or pending sale. It should be noted that other embodiments of the financial center 36 may include only some of the above-described component as well as other components not specifically mentioned in regard to the financial center 36. Further, other embodiments of the financial center 36 may exhibit other appropriate locations for the components thereof other than the particular arrangement illustrated in FIG. 2.

The financial center 36 of FIG. 2 may optionally include an appropriate device 49 to enable a customer's finger (or more particularly the fingerprint thereof) to be scanned. Incidentally, this fingerprint scanning device 49 may be any appropriate scanning device that is capable of at least assisting in electronically identifying a customer by scanning a finger (and/or fingerprint) of the customer. Examples of appropriate scanning devices that may be employed as the fingerprint scanning devices 39 and/or 49 may be optical scanners and/or capacitive scanners. In the case where payment data of the customer is coupled with fingerprint data of the customer, this fingerprint scanning device 49 may be utilized to enable the customer to pay for the desired items, at least in part, through the scanning of the customer's finger (and/or fingerprint associated therewith). Incidentally, a “fingerprint” or the like generally refers to the small ridges and troughs of the skin located toward the tip of a finger.

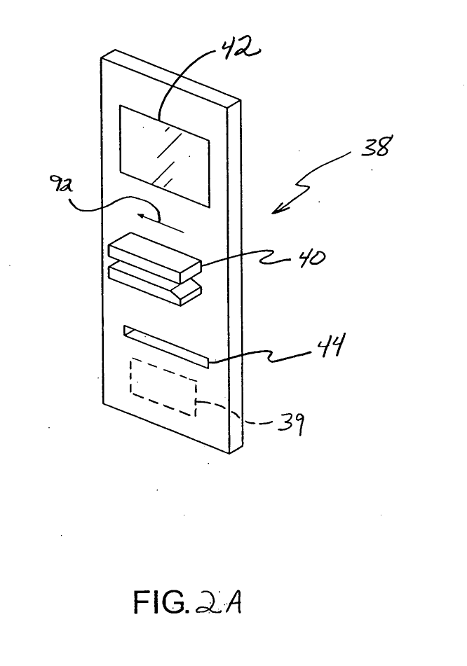

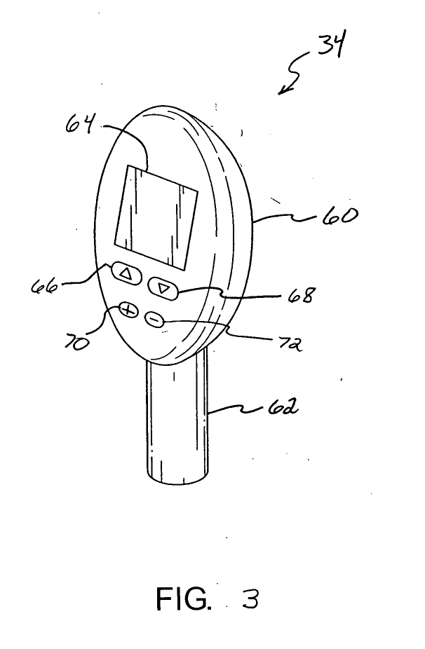

FIG. 3 illustrates one of the portable scanning devices 34 that may be supported by the support assembly 30 of the first station 22 of FIG. 2. This portable scanning device 34 includes a console 60 and a handle 62. The console 60 includes a display 64 and a plurality of operational keys. More particularly, the console 60 includes a scroll up (▾) key 66 and a scroll down (▴) key 68. In one characterization, these scroll keys 66, 68 may be utilized to enable a customer to scroll through data displayed on the display 64. Additionally and/or alternatively, it may be said that these scroll keys 66, 68 enable a customer to at least generally navigate through a variety of display screens to view desired information. In addition to the scroll keys 66, 68, the console 60 is also equipped with a plus (+) key 70 and a minus (−) key 72. The plus key 70 may be utilized to add data indicative of a selected item for purchase to information stored in the scanning device 34. This information is preferably displayed (or at least displayable) on the display 64 of the scanning device 34. The minus key 72 is located beside the plus key 70 and may be utilized to remove data indicative of a selected item for purchase from a memory of the scanning device 34. A notice of such removal is preferably displayed (or at least displayable) on the display 64 of the scanning device 34 to confirm the successful removal of data indicative of the previously selected item. Other embodiments of the scanning device 34 may include other appropriate arrangements and/or locations of the above-described keys.

It should be noted that the any number or additional and/or alternative keys may be included on the portable scanning device 34 of FIG. 3. For example, in some embodiments, an equal (=) key may be included on the scanning device to enable the a total tally of the selected items to be calculated and preferably displayed. Further, depressing this equal key twice in a threshold time period may be an appropriate procedure for authorizing payment for the selected items. In addition to the portable scanning device 34, a number of other appropriate portable scanning devices may be employed in the invention. What is important in regard to the portable scanning device (e.g., 34) employed in the invention is that it is preferably capable of enabling a customer to select an item for purchase (e.g., via scanning the UPC) and that it is preferably capable of wireless communication with a processor unit 33 of the retail store 20 at least during the purchase of one or more items. Incidentally, this processor unit 33 of the retail store may be any appropriate processor unit and may refer to a plurality of processor units. For instance, the processor unit 33 may include one processor specifically designated to functions of the sales transaction system and another processor unit that may provide more general processing functions for the retail store 20. An example of an appropriate processor unit for at least one embodiment of the invention is the IBM 4690 manufactured by IBM Corporation of White Plains, N.Y.

Referring to FIGS. 2-3, it is generally preferred that the handle 62 of the portable scanning device 34 be at least generally “recognizable” by one or more receptacles 32 of the support assembly 30. That is, it is preferred that circuitry of the support assembly 30 may be utilized to discern whether or not a receptacle 32 has a handle 62 of a scanning device 34 disposed therein. This may be accomplished in any of a variety of appropriate fashions including the use of mechanical switches and/or electrical contacts. For instance, in one embodiment, the scanning device 34 may have a first electrically conductive contact located on the handle 62 thereof, and each of the receptacles 32 of the support assembly 30 may have a second electrically conductive contact located therein. These first and second electrically conductive contacts are preferably arranged so that the same are in contact when the handle 62 of the scanning device 34 is in the receptacle 32 and so that the same are not in contact when the scanning device 34 is removed from the receptacle 32.

One benefit of utilizing the above-described contacts in relation to the handle 62 of the scanning device 34 and the receptacles 32 of the support assembly 30 may be that information (e.g., in the form of electrical signal) can be conveyed between the scanning device 34 and the support assembly 30 (and/or the processor unit 33 that may be communicatively interconnected with the support assembly 30). Another benefit of employing the above-described contacts is that energy may be conveyed to the scanning device 34 to recharge a rechargeable battery (not shown) of the scanning device 34.

Another component of the retail store 20 of FIG. 1 is at least one produce scale assembly 51. This produce scale assembly 51 is preferably electronic and preferably includes an appropriate input device to enable a person to input the type of produce to be weighed (or being weighed). Moreover, the produce scale assembly 51 also preferably includes an appropriate printer capable of printing a tag, label ,or the like that includes a bar code indicative of data representative of the type, price, and weight of the produce that was weighed thereon. This bar code may then be scanned using the portable scanning device 34 to select that produce for purchase. It should be noted that any of a number of appropriate produce scales may be employed in the produce scale assembly 51. An example of one appropriate produce scale that may be utilized in at least one embodiment of the invention is a scale assembly manufactured by Hobart Corporation of Troy, Ohio.

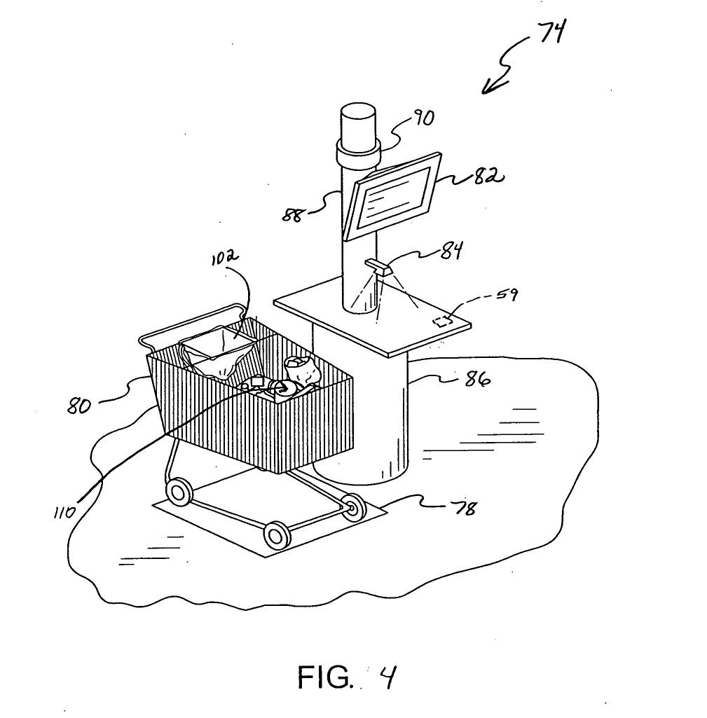

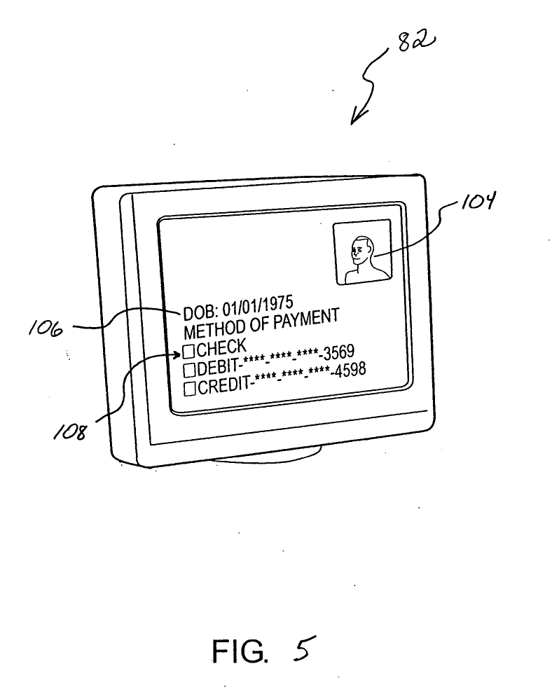

FIG. 1 illustrates that in addition to the above-described first station (e.g., 22, 22a, 22b), the retail store 20 preferably includes one or more (here, two) second stations 74 that may be referred to as exit audit stations. FIG. 4 illustrates that the second station 74 preferably includes an electronic scale assembly 78 on which a shopping cart 80 or the other appropriate transport may be placed. This scale assembly 78 is preferably communicably interconnected with a display 82 of the second station 74 so that weight data acquired through use of the scale assembly 78 may be presented on the display 82. This display 82 may be any appropriate display including, but not limited to, a television monitor and a computer screen. In the illustrated embodiment, the display 82 is preferably a touch screen. Located below the display 82 is a scanning unit 84. This scanning unit 84 may be any appropriate scanning unit and is preferably capable of scanning a bar code such as a UPC, a bar code on a sales receipt, and/or a bar code on a loyalty card.

Another component of the second station 74 illustrated in FIG. 4 is a security tag detection system 90, a portion of which is disposed toward the of a support beam 88 of the second stations 74. This security tag system 90 may be any appropriate security tag system and may be located in a number of other locations in other embodiments. For instance, in some embodiments, a portion (or even substantially all) of the security tag system may be housed at least generally within one or both of a counter assembly 86 and the support beam 88 of the second station 74. In other embodiments, the security tag system may be or include a hand-held security tag detection device. In any event, it is generally preferred that this security tag system 90 be capable of providing one or both a visual and audio signal upon detection of a security tag. The provision of this audio/visual signal may be accomplished in any of a number of appropriate fashions. For example, the audio/visual signal may be provided through use of the display 82 of the second station 74.

It should be noted that other embodiments of the second station 74 of FIG. 4 may exhibit other appropriate locations and arrangements of the features thereof. Likewise, some other embodiments may include one or more additional features and/or be devoid of some of the features listed above in relation to the second station 74. For example, the second station of FIG. 4 may optionally include an appropriate device 59 to enable a customer's finger (or more particularly the fingerprint thereof) to be scanned. This fingerprint scanning device 59 may be utilized in addition to or as an alternative to the scanning unit 84. Incidentally, this fingerprint scanning device 59 may be any appropriate scanning device that is capable of at least assisting in electronically identifying a customer, pending sale relating to the customer, and/or a completed sale relating to the customer by scanning a finger (and/or fingerprint) of the customer. Examples of appropriate scanning devices that may be employed as the fingerprint scanning device 59 may be optical scanner or capacitive scanner. In the case where birth date data of the customer is coupled with fingerprint data of the customer, this fingerprint scanning device 59 may be utilized to enable the exit audit clerk to determine the age of the customer (in the case of buying a controlled substance) through the scanning of the customer's finger (and/or fingerprint associated therewith).

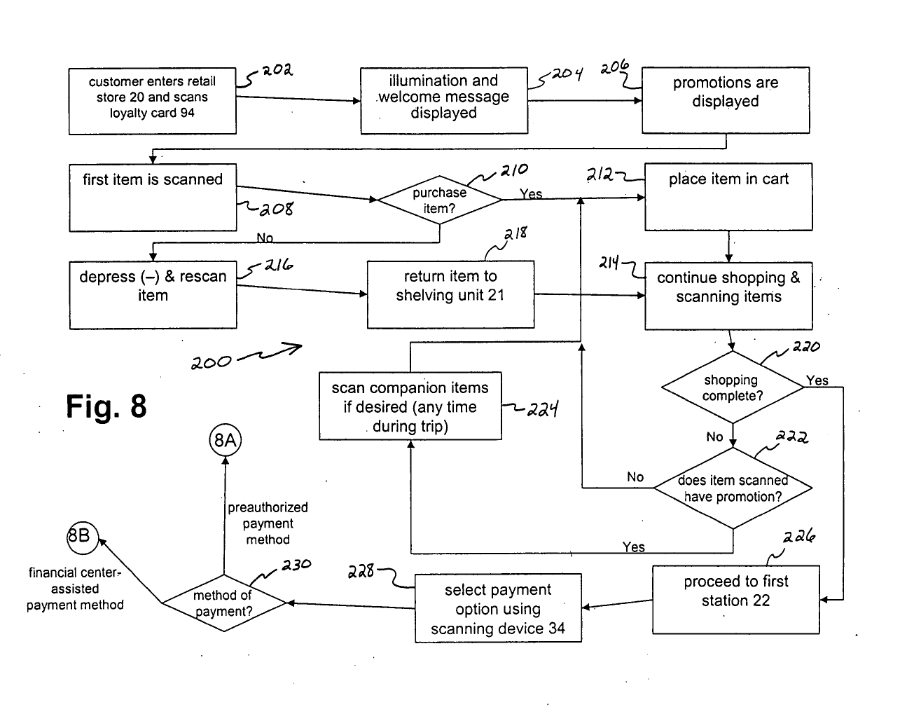

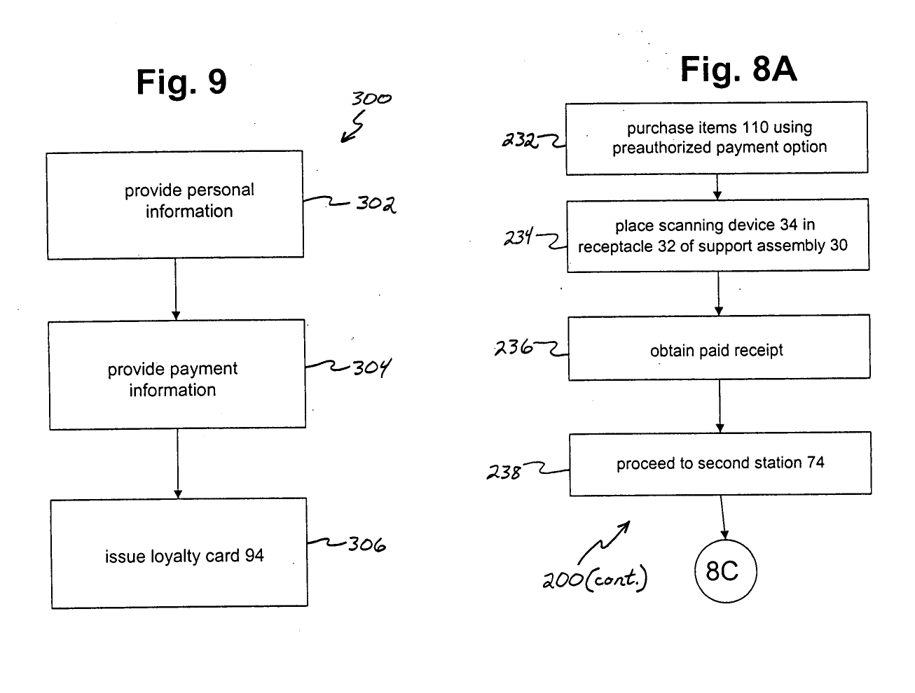

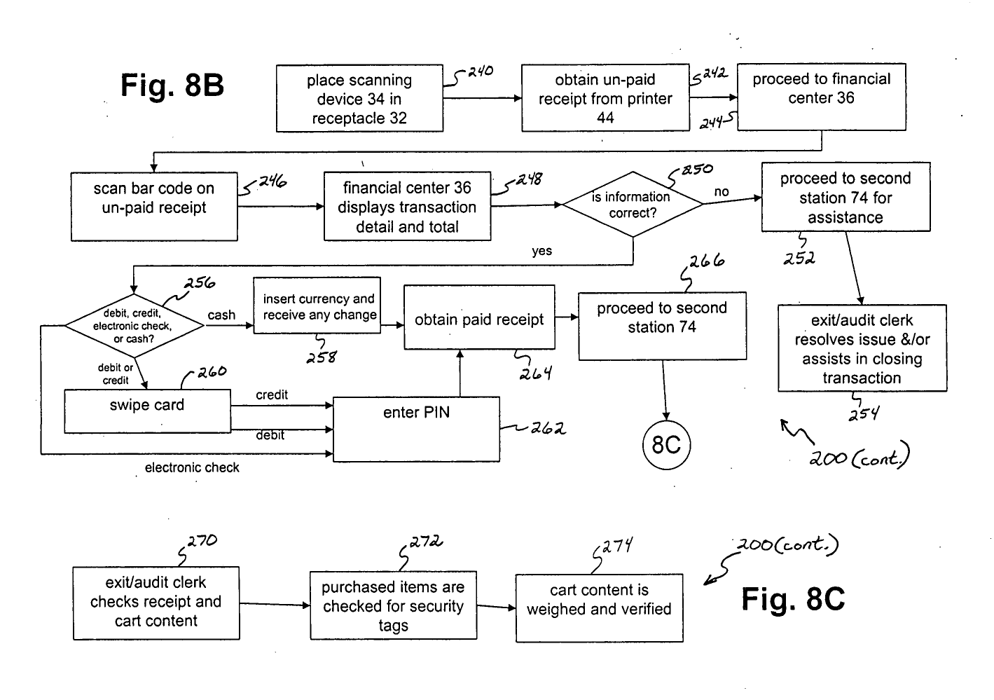

FIG. 8 illustrates a protocol 200 for transacting a sale of goods. While the retail store 20 will be utilized to facilitate description of the protocol 200, it should be noted that the protocol 200 may be utilized in a number of other retail stores. In a first step 202 of the protocol 200, a customer approaches the support assembly 30 of the first station 22 and scans his/her loyalty card 94 (e.g., 94a or 94b of FIGS. 6A-7B) by sliding the loyalty card 94 through the card reader 40 of the card reader assembly 38 in the direction indicated by arrow 92 (FIG. 2A). The loyalty card 94 is generally oriented in an appropriate manner so that a bar code 97 or magnetic strip 98 of the loyalty card 94 can be read by the card reader 40 when slid there through.

FIGS. 6A-B and 7A-B illustrate exemplary loyalty cards 94a, 94b that may be utilized in this first step 202. Referring to FIGS. 6A-B, the loyalty card 94a is preferably the shape and size of a standard credit card. The front face 95a of the loyalty card 94a may include any appropriate designs, symbols, alphanumeric characters, images (e.g., image of the customer), and the like. For example, this loyalty card 94a includes the name of a retail store “Shop-o-rama” to which the loyalty card 94a may be used. The back face 96b of the loyalty card 94a may also include any appropriate designs, symbols, alphanumeric characters, and images. In addition, this back face 96b of the loyalty card 94a includes a magnetic strip 97a and a bar code 98a (along with a series of alphanumeric characters 99a indicative of the bar code 98a). The data represented by the magnetic strip 97a and the bar code 98a is preferably specific to the customer to which the loyalty card 94a was issued. In other words, each customer has or will preferably have a loyalty card 94a with a bar code 98a and a magnetic strip 97a that differs from the loyalty cards 94a of other customers.

The loyalty card 94b of FIGS. 7A-B is similar to the loyalty card 94a of FIGS. 6A-B. However, this loyalty card 94b is preferably smaller than a standard credit card and preferably has a hole 100 defined therein (e.g., so that the loyalty card 94b may be suspended from a key ring or the like). As with the loyalty card 94a, both the front and back faces 95b, 96b (respectively) of the loyalty card 94b may include any appropriate designs, symbols, alphanumeric characters, images, and the like. Further, the back face 96b of the loyalty card 94b includes a magnetic strip 97b and a bar code 98b (along with a series of alphanumeric characters 99b indicative of the bar code 98b). In the case that a customer is issued both loyalty cards 94a, 94b shown in FIGS. 6A-7B, it is preferred that the magnetic strips 97a, 97b are substantially identical and that the bar codes 98a, 98b are also substantially identical.

As an alternative to the loyalty card scanning portion of the step 202, the customer may approach the support assembly 30 of the first station 22 and appropriately position his/her finger on or near the fingerprint scanning device 39. While not always the case, the device 39 is preferably activated by a presence of a customer's finger. The customer's finger may be scanned using the device 39, and the fingerprint data generated from that scan may be compared to previously stored fingerprint data (e.g., of the database 37) to access the biographical data and/or the payment method data specific to that customer.

Once the loyalty card 94 (or the customer's finger) is scanned, one or more electrical signals is conveyed via appropriate circuitry of the support assembly 30 to a specific receptacle 32 in which a portable scanning device 34 is located. As shown in step 204 of the protocol 200, this signal preferably causes the LED 35 associated with that receptacle 32 (and/or and LED of the scanning device 34) to illuminate and the corresponding scanning device 34 to turn on and/or exhibit a “ready” mode for use by the customer. Indeed, the display 64 of the corresponding scanning device 34 preferably illuminates and provides a textual message such as a welcome greeting. In one embodiment, this textual message is specific to the customer, including the customer's name in the text thereof. This illumination of the LED 35 and the display 64 of the scanning device 34 generally enables a customer to discern which scanning gun has been activated for that customer's use. Accordingly, the customer preferably removes the scanning device 34 from the receptacle 32 of the support assembly 30 at some point during this step 204.

As shown in step 206, various store promotions may be communicated to the customer via the display 64 of the scanning device 34. This may be accomplished in any of a number of appropriate fashions. For instance, the scanning device 34 may have an on board memory (including promotions data) that is accessed by an on board processor and is presented via the display 34 of the scanning device 34. Alternatively, the scanning device 34 is preferably wirelessly communicable with the processor unit 33 of the retail store 20. Accordingly, promotions data may simply be transmitted between the processor unit 33 and the scanning device 34. Incidentally, while it is preferred that at least some promotional data be conveyed at this early stage in the protocol 200, other embodiments of the protocol 200 include a number of other appropriate times for this step 206 to take place. Still other embodiments may not include this step 206. Relatedly, the processor unit 33 of the retail store may be utilized to communicate with the customer. Indeed, signal may be transmitted between the processor unit 33 and the scanning device 34 to provide the customer with virtually any information. For instance, if the customer has received a telephone call or someone is looking for the customer, a signal may be sent to that customer's scanning device 34 to inform the customer of the same.

The customer transports the portable scanning device 34 around the retail store 20 with him/her and shops. Once the customer finds an item that he/she desires to purchase, the customer selects the desired item for purchase by scanning the UPC associated with that item using the scanning device 34 (step 208). The item as well as the price of the item is preferably presented on the display 64 of the scanning device 34, and the price of the item is preferably added to a total tally of the selected items.

As shown at query 210 of the protocol 200, after selection of the item for purchase (step 208), the customer may decide whether or not to purchase the selected item. If the customer decides that he/she indeed wants to purchase the item after it has been selected, the customer may merely place the item in a shopping cart 80 (FIG. 4) or other appropriate carrier and continue shopping as indicated by in steps 212 and 214 of the protocol 200. With regard to the step 212, the shopping cart 80 is preferably equipped with an appropriate bag dispenser 102 that includes plurality of plastic bags. After the item has been selected (step 208), the item may be placed in a plasticbag and set in the shopping cart 80. In other words, the item(s) may be placed in a bag before the item(s) is even purchased. Further, the protocol 200 enables the purchase of the selected item(s) while the item(s) is in the bag. Incidentally, it is generally preferred that these bags are substantially transparent and/or at least generally translucent to enable store employees to discern the content(s) thereof without removing all of the contents from the bag.

Alternatively, if at some point after selection of the item in accordance with step 208 of the protocol 200, the customer changes his/her mind and decides not to purchase the selected item, the customer may deselect the item. This deselection may be accomplished in any of a number of appropriate fashions. For instance, in step 216 of the protocol 200, this deselection is accomplished by the customer depressing the minus (−) key 72 of the portable scanning device 34 and rescan the item. The scanning device 34 is preferably configured to remove the data indicative of that item from a list of selected items. Moreover, data indicative of the price of that item is also preferably subtracted from a total tally of the prices of all selected items. Accordingly, the item may be removed from the shopping cart 80 and returned to a shelving unit (e.g., 21a-e) or other appropriate location of the retail store 20 (step 218). The customer may then continue shopping and selecting other items for purchase as indicated by the step 214.

As shown in query 220, at some point(s) in the protocol 200, the customer generally decides whether shopping is complete. That is, the customer makes a determination of whether or not the selected items include all of the desired items for this shopping trip. This determination may be affected by a query 222 of whether or not any of the selected goods is associated with a marketing promotion. While this query 222 is shown as occurring after step 220, it should be noted that other embodiments include additional and/or alternative times in the protocol 200 for the query 222. For instance, this query 222 may occur immediately subsequent to the selection (e.g., scanning) of an item. Indeed, one of the beneficial features of the invention is to provide substantially real-time marketing/promotions upon selection of certain items. In other words, the scanning of a particular item for purchase may trigger a presentment of a promotion on the display 64 of the scanning device 34. In this regard, a database 37 associated with the processor unit 33 of the retail store 20 may include data indicative of various promotions. Through wireless communication of the scanning device 34 and the process unit 33, various promotion data may be conveyed to the customer. As such, the cust6mer's use of the scanning device (e.g., the selection of items) may be monitored via such wireless communication to provide purchase opportunities for the customer.

One example of a type of promotion that may be utilized in this protocol 200 is a discount feature. More particularly, after the customer has selected an item of a first brand, a signal may be transmitted from the scanning device 34 to the processor unit 33 of the retail store 20 to perform a look-up function. This look-up function is utilized to determine if a second brand of that particular item is being offered at a discount price. If that is the case, a signal from the processor unit 33 may be sent to the scanning device 34. This signal preferably of the type to cause the scanning device 34 to present information indicative of the discount offer to the customer via the display 64 of the scanning device 34. If the customer decides to stay with the item of the first brand, the message (which is preferably last only a short duration) may simply be ignored or cleared from the display 64 of the scanning device 34 by the customer pressing one or more appropriate keys. If the customer decides to purchase the competing item of the second brand, the customer may simply deselect the item of the first brand in the fashion described in the step 216 and may select the item of the second brand by scanning the bar code associated therewith. Indeed, this discount feature enables manufactures to compete for the customer's business at or shortly after selection of a particular item. Relatedly, the processor unit 33 may transmit signals to the scanning device 34 that are indicative of private label pricing of store brand goods. The discount feature, as it relates to private labeling, may enable the retail store 20 to effectively market products of its own brand (i.e., private label). Further, this discount feature may be employed to inform the customer that a different size of the product is on sale. For instance, the customer may select a 16-ounce bottle of “Brand X” ketchup. This selection may at least indirectly cause a promotion to be presented on the display 64 of the scanning device 34 that the 32-ounce size of the “Brand X” ketchup is being offered at a discounted price.

Another example of a type of promotion that may be utilized in this protocol 200 is an incentive feature. This incentive feature may be based on the customer's past purchase history, and/or demographic purchase data relevant to the geographic location of the retail store 20. Since the customer's loyalty card 94 (or fingerprint, for that matter) is preferably specific to that customer, the reading of that loyalty card 94 by the card reader 40 (or the customer's fingerprint by the fingerprint scanning device 39) may cause a signal to be transmitted to the processor unit 33 of the retail store 20 to access one or more portions of the database 37 that are relevant to the particular shopper's purchase history. If the database includes a purchase history relevant to that customer, a signal from the processor unit 33 may be wirelessly transmitted (e.g., radio frequency) to the scanning device 34 that is being used by the customer. This signal is preferably of the type to cause the scanning device 34 to present information indicative of the various promotions that are related to the types of goods the customer ordinarily purchases on the display 64 of the scanning device 34.

Yet another example of a type of promotion that may be utilized in this protocol 200 is a cross-marketing feature. This cross-marketing feature enables the promotion of items that are at least generally related to items selected by the customer. For instance, if the customer selects a jar of peanut butter by scanning the UPC on the label, the cross-marketing feature may provide a discount/incentive to the customer (via the display 64 of the scanning device 34) relating to jelly and/or bread. More particularly, after the customer has selected the first item (e.g., the peanut butter), a signal may be transmitted from the scanning device 34 to the processor unit 33 of the retail store 20 to perform a look-up function. This look-up function is utilized to determine if related items (e.g., jelly and/or bread) are being offered at a discount price. If that is the case, a signal from the processor unit 33 may be sent to the scanning device 34. This signal preferably of the type to cause the scanning device 34 to present information indicative of the cross-marketing offer to the customer via the display 64 of the scanning device 34. An example of such cross-marketing may be “save $2.00 on Brand X peanut butter when you buy Brand Y jelly.” Another example may be “get a free loaf of Brand W bread when you purchase ajar of Brand Z peanut butter.” If one or more companion items is desired for purchase by the customer, the customer may simply locate the companion item, scan the UPC (step 224), and place the selected companion item in the cart as described in relation to the step 212 of the protocol 200. For that matter, the displayed promotion may also include data indicative of a location of the retail store 20 where the companion item may be found.

Referring back to the query 220 of the protocol 200, if the customer determines that shopping is complete, the customer may proceed to toward the support assembly 30 of the first station 22 (step 226). Prior to or during heading toward the first station 22, the customer may select a payment option from those presented on the display 64 of the scanning device 34 (step 228). Indeed, due to the portable nature of the scanning device 34 in addition to the wireless communication feature it provides, the selected items may be purchased by the consumer at any location in the retail store 20. In any event, as shown in query 230 of the protocol 200, the customer may be presented with one or more payment options, depending on the payment options that the customer authorized when his/her loyalty card 94 was issued. Payment options that may be presented include preauthorized credit, debit, and/or electronic check (FIG. 8A), or financial center-assisted payment including credit, debit, electronic check, and/or cash (FIG. 8B).

The portion of the protocol 200 that corresponds to a preauthorized payment is illustrated in FIG. 8A. As shown in step 232 of the protocol 200, the customer may pay for the selected items by choosing the option that coincides with preauthorized payment using credit card, debit card, or electronic check information that is already on file in the database 37 of the retail store 20 (step 228 of FIG. 8). This may be accomplished in any of a variety of appropriate fashions. For instance, the customer may scroll through the payment options that are presented on the display 64 of the scanning device 34 using one or more of the scroll keys 66, 68 until the desired preauthorized option is highlighted. The customer may then press the plus key 70 to select that option for payment. A signal from the scanning device 34 may then be wirelessly transmitted to the processor unit 33 of the retail store 20 to complete the sale. In some embodiments, this step 232 may also include a query asking the customer to enter a PIN number or other appropriate data, such as an electronic signature, using the keys of the scanning device 34 to complete the purchase. Accordingly, it may be said that the protocol 200 enables a customer to actually purchase the selected items from virtually any location in the retail store 20.

After the purchase has been made in accordance with the step 232 of the protocol 200, the customer may then return the first station 22 and place the scanning device 34 (or at least a portion thereof) into one of the receptacles 32 of the support assembly 30 that is not already occupied by a scanning device 34 (step 234). This placement of the scanning device 34 in the receptacle 32 preferably causes a signal to be provided. This signal generally causes the printer 44 to print out a receipt memorializing the customer's purchases. This receipt preferably includes information conveying that the customer has indeed paid for the selected items, information relating to the method of payment, and a bar code that may be scanned to access an electronic record of the sales transaction. In embodiments of the first station 22 that do not include a printer 44, placement of the scanning device 34 in the receptacle 32 may cause the printer 56 of the financial center 36 to print out an appropriate receipt. As shown in steps 236 and 238 (respectively), the customer may then obtain the receipt and proceed to the second station 74 for an audit portion (FIG. 8F) of the protocol 200. Some embodiments of the protocol 200 may even pair the placement of the scanning device 34 in the receptacle 32 with the printing of an appropriate receipt from a printer associated with the second station 74.

In a variation of the steps 232 and 234, the selection of the preauthorized purchase option may be said to fix the sale of the items. That is, this selection may not include a wireless transmission of signal to complete the sales transaction. Instead, once an appropriate electrical contact of the scanning device 34 interfaces with a contact of the receptacle 32 in which the scanning device 34 is placed, data relating to the authorized purchase may be conveyed from the scanning device 34 (via the contacts) through the support structure 30 and to the processor unit 33 of the retail store 20 via appropriate communicative interconnections between the support structure 30 and the processor unit 33. As such, this variation includes storage of the customer's direction for purchase in an appropriate on-board memory of the scanning device 34 until that data can be relayed to the processor unit 33 via the support structure 30. A receipt may then be provided for the customer in a manner at least similar to that described above.

Referring to FIGS. 8 and 8B, in the case that credit card information, debit/ATM card information, and/or electronic check information is not on file for that customer in the database 37, or in the case that the customer simply chooses to make payment via an actual handling of a payment object (e.g., credit card, debit card, or cash), the customer may simply select that payment option from those presented via the display 64 of the scanning device 34 (step 228). This may be accomplished in any of a variety of appropriate fashions. For instance, the customer may scroll through the payment options that are presented on the display 64 of the scanning device 34 using one or more of the scroll keys 66, 68 until the financial center-assisted option is highlighted. The customer may then press the plus key 70 to select that option for payment. Indeed, the customer may choose to utilize the financial center 36 to pay by cash, electronic check, debit card, or credit card. After selection of the desired purchase manner, a signal from the scanning device 34 may be wirelessly transmitted to the processor unit 33 of the retail store 20 that indicates the selection of that option. Alternatively, the selection of that option may be stored in an appropriate on-board memory of the scanning device 34 at least until the scanning device 34 is placed in a receptacle 32 of the support assembly 30.

Still referring to FIG. 8B, after selection of the financial center-assisted option for payment, the customer may then place the scanning device 34 into one of the receptacles 32 of the support assembly 30 of the first station 22 that is not already occupied by a scanning device 34 (step 240). This placement of the scanning device 34 in the receptacle 32 preferably causes a signal to be provided. This signal generally causes the printer 44 to print out a receipt listing the customer's selected items and indicating that the customer has not yet paid for those selected items. In addition, this receipt also includes a bar code related to the pending sale. Incidentally, in embodiments of the first station 22 that do not include a printer 44, placement of the scanning device 34 in the receptacle 32 may cause the printer 56 of the financial center 36 to print out the unpaid receipt. As shown in steps 242, the customer may then obtain the unpaid receipt and proceed to the financial center 36 (step 244). The receipt (or more particularly, a bar code thereon) is preferably read by a scanner 47 of the financial center 36 (step 246). The reading of this bar code by the financial center 36 generally causes the processor unit 33 and/or the database 37 associated therewith to be accessed (through appropriate communicative interconnections with the financial center 36), and data indicative of the pending sales transaction is preferably presented on the display 54 of the financial center 36 (step 248). As an alternative to scanning the bar code of the receipt, the customer's loyalty card 94 may be scanned using the scanner 47 of the financial center 36 to bring up the pending sale information. As another alternative, the customer's fingerprint may be scanned using the scanning device 49 of the financial center 36 to access the pending sale information.

Referring to query 250 of the protocol 200, one benefit of displaying this pending sales transaction data is that the customer may make a determination as to whether the information displayed is correct (i.e., does the displayed information coincide with what is believe to be the selected items?). If the information presented on the display 54 of the financial center 36 is incorrect, or if the customer has chosen to pay by paper check, the customer may proceed to the second station 74 (step 252) where an appropriate employee (e.g., exit audit clerk) of the retail store 20 may resolve any errors in the pending transactions and/or assist in closing the transaction by accepting payment (e.g., a paper check) there (step 254).

By contrast, and still with regard to the query 250 of the protocol 200, if the information presented on the display 54 of the financial center 36 is indeed correct, another query 256 is made as to the desired method of payment. Incidentally, this query 256 may not be present in all embodiments of the protocol 200. For instance, in the case that the specific method of financial center-assisted payment is selected using the portable scanning device 34, and that information is electronically relayed to the financial center 36, this query 256 may be skipped.

If the method of payment chosen includes cash, the customer tenders at least that amount of cash to the financial center 36 utilizing the cash input 48 thereof and receives any change owing from one or both of the cash return 50 and the change return 52 of the financial center 36 (step 258). Alternatively, if the customer chooses to pay via credit card, the credit card may be inserted or swiped in the card reader 46 of the financial center 36 to complete the sale (step 260). In some embodiments of the protocol 200, this step 260 may be accompanied by a requirement that the customer enter an electronic signature or PIN number utilizing any of a number of appropriate manners known to those of skill in the art. As another alternative, if debit/ATM card is the desired method of payment, that card may be inserted or swiped in the card reader 46 of the financial center 36 to complete the sale. Still another alternative enables the customer to pay via electronic check. While not always the case, it is generally preferred that the customer be required to enter a PIN number to utilize the credit, debit/ATM and/or electronic check methods of payment (step 262).

As another possible method of payment, the customer may have his/her fingerprint scanned by the fingerprint scanning device 49 of the financial center 36 to access the pending transaction as well as payment data of that customer that is stored in the database 37. In this regard, the scanning of the customer's fingerprint may substitute for a scanning of the customer's loyalty card 94 or receipt using the scanner 47 of the financial center 36. Further, this scanning of the customer's fingerprint may substitute for a reading of a credit card or debit card by the card reader 46 of the financial center 36.

Regardless of the method of financial center-assisted payment utilized, the financial center 36 preferably provides a receipt (via the printer 56) for the customer. This receipt preferably includes a transaction-specific bar code and preferably indicates that payment has been made by the customer, as well as the method of in which payment was made. Once the customer has obtained the paid receipt (step 64), the customer may proceed to the second station (step 266) for an exit audit portion of the protocol 200.

FIG. 8C illustrates what may be characterized as the exit audit portion of the protocol 200. In this portion of the protocol 200, the shopping cart 80 with the purchased items disposed therein is transported to the second station 74. There, the customer provides the sales receipt generated by the printer 56 or the printer 44 (depending on the method of payment utilized) to an appropriate store employee, and the receipt and content of the shopping cart 80 are analyzed (step 270). This analysis may be accomplished in any appropriate fashion including a visual inspection comparing at least some of the items listed on the receipt to those present in the shopping cart 80. For instance, items generally having a higher sale price may be singled out to determine if that item is indicated on the paid receipt. Having the purchased items in bags that are substantially transparent during this step may be said to at least generally assist the employee in viewing the content thereof without removing the entire content of the bag(s).

Still with regard to this step 270 of the protocol 200, the paid receipt (more particularly, the bar code thereon) may be scanned at the second station 74 utilizing the scanning unit 84. This scanning of the receipt may cause data to be presented on the display 82 of the second station 74. For instance, an image 104 and/or biographical data 106 (e.g., previously obtained in an enrollment protocol) of the customer may be presented on the display 82 in response to scanning the receipt bar code. This data may be displayed to confirm that the customer in possession of a given loyalty card 94 is indeed the person to which the loyalty card 94 was issued. In some embodiments, based on the scanning of the receipt bar code, a determination may be made as to whether or not one or more of the purchased items is a controlled substance such as tobacco products and/or alcoholic beverages. In the case that the purchased items do include one or more controlled substances, data indicative of an age of the customer may be compared (e.g., electronically) to data indicative of a minimum legal age requirement to purchase the controlled substance. Access and/or the display of this age-indicative data relating to the customer may be triggered by the scanning of the customer's receipt or loyalty card 94 using the scanning device 84, as well as by scanning the customer's fingerprint using the fingerprint scanning device 59. This comparison may be accomplished in any appropriate manner including electronically and/or via an employee of the retail store. In this regard, the use of the protocol 200 may be said to provide an enhanced manner of regulating sales of controlled substances. Other data may also be shown on the display 82 including, but not limited to, authorized methods of payment 108 for that customer. Incidentally, while the display 82 may be any of a number of appropriate displays, it is preferably a touch screen that enables an employee or the like to view data and/or navigate to/through data by touching the screen (in one or more appropriate locations).

In step 272 of the protocol 200, the items are checked for security tags or the like. Indeed, the second station 74 is equipped with an appropriate security tag detection system 90 that may be utilized to determine if security tagged items are located within the range of the system 90. The system 90 may provide any appropriate notification upon detection of a security tag. For instance, an audible sound (e.g., alarm) may be provided. Additionally and/or alternatively, a visual signal such as light and/or the presentment of notice on the display 82 may be appropriate. If it is determined that a tag is present, the tagged item may be removed from the shopping cart 80 so that the tag can be deactivated. Further, if it is determined that a tag is present, and the shopping cart 80 does not contain any items that are regularly tagged, the employee may infer that one or more tagged items is located on the person of the customer. In this regard, the protocol 200 may at least generally prevent undesired reduction in profit margins due to theft.

In another step 274 of the exit audit portion of the protocol 200, the cart content may be said to be weighed and verified. More particularly, the shopping cart 80 with the items 110 disposed therein is placed on the scale 78 of the second station 74. The shopping cart 80 preferably exhibits a known weight. Likewise, each of the purchased items preferably has predetermined weight data associated with the UPC. Accordingly, a theoretical weight of the cart 80 and the items contained therein may be determined and printed on the customer's receipt at some point prior to the step 270 of the protocol 200. Additionally or as alternative to having the receipt include the theoretical weight of the cart and purchased goods, the theoretical weight may be displayed via the display 82 of the second station 74, which is preferably interconnected with the processor unit 33 of the retail store 20. Indeed, it is preferred that predetermined weight data be associated with the corresponding UPC of every item that is for sale in the retail store 20. This predetermined weight data is preferably stored in the database 37 associated with the processor unit 33. In other words, the database 37 generally includes weight data and price data for each of the items in the retail store 20. And, the weight and price data is preferably associated with an identification code (e.g., UPC) for each of the items. The step 274 of the protocol 200 generally enables an audit of the cart content by comparing the combined theoretical weight of the cart and each of the purchased items to the actual weight of the cart and the items therein. This comparison may be done in any appropriate fashion including employee-based comparison of the actual and theoretical weights and/or electronic comparison of the same. If the two weights do not match or are not with in an acceptable deviation range, an employee may make an item-by-item comparison of the purchased items versus the one contained in the shopping cart 90 to determine a reason for variation in weights. If the two weights match or are within the acceptable deviation range, the audit is complete, and the customer may leave the retail store 20 with the purchased items.

It is important to note that the particular order of the steps involved in the audit portion of the protocol 200 is not critical. Accordingly, other embodiments of the protocol 200 may include other appropriate orders of the steps 270, 272, 274, as well as portions thereof. Further, other embodiments of the exit audit portion of the protocol 200 may include additional steps not illustrated in FIG. 8C. One important note is that this exit audit portion of the protocol 200 occurs after all of the items have been purchased. The flexible payment options of the protocol 200 and the minimal employee-based support may be said to beneficially enable customers to spend less time in lines waiting to check out.

FIG. 9 illustrates a sign-up and issuance protocol 300 to enable a customer to acquire a loyalty card 94. On the first day of participation, a customer may enter the retail store 20 and proceed to an appropriate sign-up area 112. There, the customer may be asked to provide personal information (step 302) including any of a number of appropriate forms of identification (e.g., driver's license or state-issued identification) and/or other biographical data such as, but not limited to, address, email address, telephone number, social security number, and birth date.

In addition to the collection of personal data, the sign-up and issuance protocol 300 also includes the collection of authorized payment method from the customer (step 304). In this step, the customer may provide credit card information, debit/ATM card information, and/or electronic check information. The provision of such information in regard to these preauthorized methods of payment preferably enables a customer to utilize the portion of the protocol 200 illustrated in FIG. 8A.

Upon collecting the personal and payment method information related to that particular customer, a loyalty card 94 that is specific to that customer may be issued to the customer (step 306). Incidentally, the above-described payment method information, along with the personal information, of the customer is preferably stored on the database 37 in connection with the data of the loyalty card 94. Additionally or alternatively, the payment method information and personal information of the customer may be coupled to the customer's unique fingerprint data. In this regard, the customer's fingerprint may be said, at least in one embodiment, to actually serve the function of the loyalty card 94.

The personal and payment information that is coupled with one or both the customer's loyalty card data and fingerprint data is preferably accessible from the database 37 during the protocol 200. For instance, if a preauthorized payment option is selected in response to the query 230, a wireless transmission of signal preferably takes place between the scanning device 34 and the processor unit 33 in which the processor unit 33 accesses the database 37 to determine if that selected payment option has been preauthorized by the customer. As another example, the during the exit audit portion of the protocol 200, the scanning of the receipt in the step 270 preferably causes the database 37 to be accessed to provide data relating to the customer as well as the most recent sales transaction.

Some retail stores may already utilize some form of a loyalty card 94. In such retail stores, the protocol 300 may be modified to allow the customer to provide the above-described personal and payment information, and the bar code and/or magnetic strip of the existing loyalty card 94 may be used to correspond the collected data with data indicative of that particular loyalty card 94. For example, data indicative of the bar code of the existing loyalty card 94 may be paired with the information in the portion of the database 37 dedicated to that particular customer so that information may be utilized during the protocol 200.

Those skilled in the art will now see that certain modifications can be made to the system and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

What is claimed is:

1. A method of transacting a sale, the method comprising the steps of:
selecting a first item for purchase, wherein said selecting step comprises scanning a first bar code associated with said first item using a portable scanning device, and wherein said selecting step occurs at a first location of a retail store; and
purchasing said first item using said portable scanning device, wherein said purchasing step comprises wireless transmission of signal between said portable scanning device and a processing unit of said retail store.

2. A method, as claimed in claim 1, wherein:
said selecting step comprises selecting a second item for purchase, wherein said selecting a second item step comprises scanning a second bar code associated with said second item using said portable scanning device, and wherein said selecting a second item step occurs in a second location of said retail store remote from said first location.

3. A method, as claimed in claim 2, further comprising:
deselecting said second item for purchase after said selecting step, wherein said deselecting step comprises scanning said second bar code associated with said second item using said portable scanning device.

4. A method, as claimed in claim 2, wherein:
said purchasing step comprises purchasing said second item using said portable scanning device, wherein said purchasing said second item step comprises wireless transmission of signal between said portable scanning device and said processing unit of said retail store.

5. A method, as claimed in claim 4, wherein:
said purchasing said first item step and said purchasing said second item step occur in a third location of said retail store remote from said first and second locations.

6. A method, as claimed in claim 5, further comprising:
auditing said purchasing step, wherein said auditing step comprises weighing said first item after said purchasing step, and wherein said auditing step occurs at a fourth location of said retail store that is remote from said first, second, and third locations.

7. A method, as claimed in claim 5, further comprising:
auditing said purchasing step, wherein said auditing step comprises weighing said first item after said purchasing step, and wherein said auditing step occurs at said third location of said retail store.

8. A method, as claimed in claim 4, wherein:
said purchasing said first item step and said purchasing said second item step occur in at least one of said first and second locations of said retail store.

9. A method, as claimed in claim 1, further comprising:
auditing said purchasing step, wherein said auditing step comprises weighing said first item after said purchasing step, and wherein said auditing step occurs at a second location of said retail store that is remote from said first location.

10. A method, as claimed in claim 1, further comprising:
auditing said purchasing step, wherein said auditing step comprises weighing said first item after said purchasing step; and
disposing said first item in a bag that is at least one of transparent and translucent prior to said auditing step.

11. A method, as claimed in claim 10, wherein:
said first item is located in said bag during said auditing step.

12. A method, as claimed in claim 1, further comprising:
disposing said first item in a bag, at least a majority of which is at least one of substantially transparent and translucent, wherein said first item is located in said bag throughout said purchasing step.

13. A method, as claimed in claim 12, wherein:
said first item is disposed in said bag during said purchasing step.

14. A method, as claimed in claim 13, further comprising:
auditing said purchasing step, wherein said auditing step comprises weighing said first item after said purchasing step, and wherein said first item is located in said bag during said auditing step.

15. A method, as claimed in claim 1, wherein:
said selecting step is accomplished in an aisle of said retail store, and wherein said retail store is a supermarket.

16. A method, as claimed in claim 1, further comprising:
providing a customer with said portable scanning device prior to said selecting step if said customer presents an identification card previously provided by said retail store.

17. A method, as claimed in claim 16, wherein:
said selecting and purchasing steps are accomplished by said customer.

18. A method, as claimed in claim 1, further comprising:
removing said portable scanning device from a support assembly supporting a plurality of portable scanning devices prior to said selecting step; and
disposing said portable scanning device on said support assembly subsequent to said purchasing step.

19. A method, as claimed in claim 18, further comprising:
printing a sales receipt, wherein said printing step occurs after said disposing step.

20. A method, as claimed in claim 1, further comprising:
disposing said first item in a carrier after said selecting step, wherein said carrier is selected from the group consisting of a cart, a bag, and a basket; and
auditing said purchasing step while said first item is disposed in said carrier, wherein said auditing step comprises weighing at least said first item after said purchasing step.

21. A method, as claimed in claim 20, wherein:
said purchasing step is accomplished while said first item is disposed in said carrier.

22. A method, as claimed in claim 1, further comprising:
auditing said purchasing step after said purchasing step, wherein said auditing step comprises:
weighing said first item; and
monitoring for a presence of a security tag associated with said first item.

23. A method, as claimed in claim 1, further comprising:
auditing said purchasing step after said purchasing step; and
printing a sales receipt after said purchasing step and before said auditing step.

24. A method, as claimed in claim 23, wherein:
said sales receipt comprises a receipt bar code, and wherein said auditing step comprises scanning said receipt bar code.

25. A method, as claimed in claim 24, wherein:
said selecting and purchasing steps are accomplished by a customer, and wherein said auditing step comprises electronically displaying an image of said customer in response to said scanning said receipt bar code step.

26. A method, as claimed in claim 24, wherein:
said selecting and purchasing steps are accomplished by a customer, and wherein said auditing step comprises electronically providing biographical data of said customer in response to said scanning said receipt bar code step.

27. A method, as claimed in claim 26, wherein:
said auditing step comprises determining if said first item is a controlled substance selected from the group consisting of tobacco products and alcoholic beverages based on said scanning said receipt bar code step.

28. A method, as claimed in claim 27, wherein:
said selecting and purchasing steps are accomplished by a customer, and wherein said auditing step comprises comparing data indicative of an age of said customer to data indicative of a minimum legal age requirement to purchase said controlled substance.

29. A method of transacting a sale, the method comprising the steps of:
selecting a first item for purchase, wherein said selecting step comprises scanning a first bar code associated with said first item using a portable scanning device;
purchasing said first item; and
auditing said purchasing step after said purchasing step, wherein said auditing step comprises:
weighing said first item; and
comparing a first weight corresponding to a theoretical weight of at least said first item to a second weight corresponding to an actual weight of at least said first item.

30. A method, as claimed in claim 29, wherein:
said selecting step comprises selecting a second item for purchase, wherein said selecting a second item step comprises scanning a second bar code associated with said second item using said portable scanning device;
said purchasing step comprises purchasing said first and second items using said portable scanning device, wherein said purchasing said first and second items step comprises wireless transmission of signal between said portable scanning device and said processing unit of said retail store;
said weighing step of said auditing step comprises collectively weighing said first item and second items; and
said first weight of said comparing step of said auditing step corresponds to a cumulative theoretical weight of at least said first and second items; and
said second weight of said comparing step of said auditing step corresponds to an actual cumulative weight of at least said first and second items.

31. A method, as claimed in claim 30, wherein:
said first weight of said comparing step of said auditing step corresponds to a cumulative theoretical weight of at least said first item, said second item, and an item transport; and
said second weight of said comparing step of said auditing step corresponds to an actual cumulative weight of at least said first item, said second item, and said item transport.

32. A method, as claimed in claim 31, wherein:
said item transport is selected from the group consisting of a cart and a basket.

33. A method, as claimed in claim 29, wherein:
said auditing step comprises monitoring for a presence of a security tag associated with said first item after said purchasing step.

34. A method, as claimed in claim 33, wherein:
wherein said purchasing step comprises wireless transmission of signal between said portable scanning device and a processing unit of said retail store.

35. A method, as claimed in claim 34, further comprising:
printing a sales receipt after said purchasing step and before said auditing step.

36. A method, as claimed in claim 35, wherein:
said sales receipt comprises a receipt bar code, and wherein said auditing step comprises scanning said receipt bar code.

37. A method, as claimed in claim 36, wherein:
said selecting and purchasing steps are accomplished by a customer, and wherein said auditing step comprises electronically displaying an image of said customer in response to said scanning said receipt bar code step.

38. A method, as claimed in claim 36, wherein:
said selecting and purchasing steps are accomplished by a customer, and wherein said auditing step comprises electronically providing biographical data of said customer in response to said scanning said receipt bar code step.

39. A method, as claimed in claim 38, wherein:
said auditing step comprises determining if said first item is a controlled substance selected from the group consisting of tobacco products and alcoholic beverages based on said scanning said receipt bar code step.

40. A method, as claimed in claim 39, wherein:
said selecting and purchasing steps are accomplished by a customer, and wherein said auditing step comprises comparing data indicative of an age of said customer to data indicative of a minimum legal age requirement to purchase said controlled substance.

41. A method, as claimed in claim 29, further comprising:
disposing said first item in a bag that is at least one of transparent and translucent prior to said auditing step.

42. A method, as claimed in claim 41, wherein:
said first item is disposed in said bag during said auditing step.

43. A method, as claimed in claim 29, further comprising:
disposing said first item in a bag that is at least one of transparent and translucent prior to said purchasing step.

44. A method, as claimed in claim 43, wherein:
said first item is disposed in said bag during said purchasing step.

45. A method, as claimed in claim 44, wherein:
said first item is disposed in said bag during said auditing step.

46. A method, as claimed in claim 29, wherein:
said selecting and purchasing steps are accomplished by a customer.

47. A method of transacting a sale, the method comprising the steps of:
issuing a loyalty card to a customer, wherein said issuing step comprises electronically coupling loyalty card data indicative of said loyalty card with biographical data of said customer and payment data of said customer;
electronically reading said loyalty card, wherein said electronically reading step comprises electronically accessing at least one of said biographical data and said payment data; and
purchasing a first item, wherein said purchasing step comprises utilizing said at least one of said biographical data and said payment data of said accessing step.

48. A method, as claimed in claim 47, wherein:
said issuing step comprises electronically coupling visual image data of at least one of said customer and a state-issued identification of said customer to said loyalty card data.

49. A method, as claimed in claim 48, further comprising:
auditing said purchasing step after said purchasing step, wherein said auditing step comprises electronically displaying a visual image corresponding to at least some of said visual image data of said issuing step.

50. A method, as claimed in claim 49, wherein:
said auditing step comprises weighing said first item after said purchasing step.

51. A method, as claimed in claim 47, wherein:
said biographical data comprises birth date data of said customer.

52. A method, as claimed in claim 51, wherein:
said first item is a controlled substance selected from the group consisting of tobacco products and alcoholic beverages, and wherein said purchasing step comprises electronically accessing said birth date data.

53. A method, as claimed in claim 52, further comprising:
auditing said purchasing step after said purchasing step, wherein said auditing step comprises electronically displaying said birth date data.

54. A method, as claimed in claim 47, wherein:
said purchasing step comprises utilizing said payment method data.

55. A method, as claimed in claim 47, further comprising:
allowing a portable scanning device to be removed from a structure supporting a plurality of portable scanning devices, wherein said allowing step is in response to said electronically reading step.

56. A method, as claimed in claim 55, wherein:
selecting said first item for purchase, wherein said selecting step comprises scanning a first bar code associated with said first item using said portable scanning device.

57. A method, as claimed in claim 56, wherein:
said purchasing step comprises wireless transmission of signal from a portable scanning device.
